(19) United States
(12) Patent Application Publication
(10) Pub. No.: US 2023/0065026 A1
(43) Pub. Date: Mar. 2, 2023

(54) BATTERY REPLACEMENT SYSTEM AND CONTROL METHOD FOR BATTERY REPLACEMENT SYSTEM

(71) Applicants: AULTON NEW ENERGY AUTOMOTIVE TECHNOLOGY GROUP, Guangzhou, Guangdong (CN); SHANGHAI DIANBA NEW ENERGY TECHNOLOGY CO., LTD., Shanghai (CN)

(72) Inventors: Jianping Zhang, Shanghai (CN); Chunhua Huang, Shanghai (CN)

(21) Appl. No.: 17/794,675

(22) PCT Filed: Jan. 25, 2021
(86) PCT No.: PCT/CN2021/073658

§ 371 Date: Nov. 11, 2022

(30) Foreign Application Priority Data
Jan. 23, 2020 (CN) 202010076984.7

(51) Int. Cl. B60L 53/80; B60S 5/06

(52) U.S. Cl. CPC B60L 53/80; B60S 5/06

(57) ABSTRACT

Disclosed are a battery replacement system and a control method for the battery replacement system. The battery replacement system comprises a walking channel (2) and a battery replacement apparatus (1), wherein a battery replacement position (4) is provided on the walking channel (2), and the battery replacement apparatus (1) is used for moving to the battery replacement position (4) along the walking channel (2). The battery replacement system and the control method for the battery replacement system can realize rapid battery replacement operation and improve the battery replacement efficiency and the stability of the battery replacement operation.

This application claims priority of Chinese patent application 2020100769847, filed on Jan. 23, 2020. The contents of which are incorporated herein by reference in their entirety.

### TECHNICAL FIELD

The present invention relates to a battery replacement system.

The invention further relates to a control method for the battery replacement system.

### BACKGROUND

Existing battery replacement systems use a battery replacement trolley (i.e. a battery replacement apparatus) to replace the battery pack of an electric vehicle, the replacement process includes unlocking the battery pack from the bottom of the electric vehicle, removing and transporting the battery pack to a stacker crane, transporting the battery pack from the stacker crane to the electric vehicle and installing the battery pack on the electric vehicle.

However, in the prior art, it is difficult to control the accuracy of the position of the battery replacement trolley, which makes it difficult to align the trolley with the electric vehicle, thus affecting the removal and installation of the battery pack and leading to unstable operation of the battery replacement system.

### CONTENT OF THE INVENTION

The technical problem to be solved by the present invention is to provide a battery replacement system and a control method for the battery replacement system in order to overcome the defects of the prior art that it is difficult to align the battery replacement trolley with the electric vehicle.

The present invention solves the above technical problems by means of the following technical solutions:

a battery replacement system, the battery replacement system comprising:

a walking channel, a battery replacement position is provided on the walking channel;

a battery replacement apparatus, the battery replacement apparatus is used for moving to the battery replacement position along the walking channel.

In this technical solution, by controlling the movement of the battery replacement apparatus in the walking channel, making the battery replacement apparatus be able to align with the electric vehicle to complete the removal or installation of the battery pack and improve the stability of the battery replacement system operation.

Preferably, the battery replacement position is provided with an alignment original point and the battery replacement apparatus is provided with an alignment sensor, or the battery replacement position is provided with an alignment sensor and the battery replacement apparatus is provided with an alignment original point, and the alignment sensor is used to detect whether the battery replacement apparatus has reached the alignment original point.

In this technical solution, the alignment sensor is used to detect the position of the alignment original point, and when the alignment sensor detects the alignment original point, it indicates that the battery replacement apparatus has reached the battery replacement position, so that the battery replacement apparatus can accurately stop at the battery replacement position.

Preferably, an exchange position is provided on the walking channel, the battery replacement apparatus is used to move to the exchange position along the walking channel, and the battery replacement apparatus is also used to exchange the battery pack to a battery compartment at the exchange position.

In this technical solution, the battery replacement apparatus can stop at the exchange position and place the removed battery pack in the battery compartment at the exchange position and remove the charged battery pack from the battery compartment to achieve the exchange of the battery pack.

Preferably, the exchange position is provided with an exchange original point and the battery replacement apparatus is provided with an exchange sensor, or the exchange position is provided with an exchange sensor and the battery replacement apparatus is provided with an exchange original point, and the exchange sensor is used to detect whether the battery replacement apparatus has reached the exchange original point.

In this technical solution, by using the exchange sensor to detect the exchange original point, it enables the battery replacement apparatus to be accurately positioned in the exchange position, ensuring that the operation of the replacement battery pack can be operated stably.

Preferably, the walking channel connects the battery compartment and the battery replacement position, the walking channel is provided with a deceleration positioning point, the battery replacement apparatus is provided with a deceleration sensor corresponding to the deceleration positioning point, the deceleration sensor is used to detect whether the battery replacement apparatus has reached the deceleration positioning point, the battery replacement apparatus is also used to move towards the battery replacement position along the walking channel to pass the deceleration positioning point and then decelerate the movement.

In this technical solution, the battery replacement apparatus moves between the battery compartment and the battery replacement position, and the battery replacement apparatus moves quickly before reaching the deceleration positioning point to improve operational efficiency; the battery replacement apparatus decelerates after passing the deceleration positioning point to ensure accurate positioning, reduce control difficulties and improve the safety of the operation of the battery replacement apparatus.

Preferably, the walking channel has a first waiting position, the first waiting position is located between the battery replacement position and the exchange position, and the battery replacement apparatus is used to stop at the first waiting position.

In this technical solution, a number of battery replacement apparatuses can exist simultaneously in one battery replacement system, and when there is a battery replacement apparatus at a battery replacement position, other battery replacement apparatuses can stop at the first waiting position.

Preferably, the walking channel has a second waiting position, the battery replacement position is located between the second waiting position and the exchange position, and the battery replacement apparatus is used to stop at the second waiting position.

In this technical solution, a number of battery replacement apparatus can exist simultaneously in one battery replacement system, and when there is a battery replacement apparatus at the exchange position, other battery replacement apparatuses can stop at the second waiting position.

Preferably, there are two battery replacement apparatuses, the two battery replacement apparatuses are a first battery replacement apparatus and a second battery replacement apparatus, a first track for the first battery replacement apparatus to walk on and a second track for the second battery replacement apparatus to walk on are arranged in the walking channel, the first track connects the battery compartment and the exchange position and the second track connects the battery compartment and the battery replacement position.

In this technical solution, the two battery replacement apparatuses perform the operation of removing and installing battery packs separately, thus increasing the speed of the battery replacement. For example, when the first battery replacement apparatus removes the battery pack at the battery replacement position, the second battery replacement apparatus can take out the charged battery pack from the battery compartment, after the first battery replacement apparatus removes the battery pack and leaves the battery replacement position, the second battery replacement apparatus can move carrying the battery pack to the battery replacement position and install the battery pack on the electric vehicle, at this time, the first battery replacement apparatus can complete the replacement of new and old batteries in the battery compartment, the two battery replacement apparatuses can operate on the first track and the second track respectively, with high battery replacement efficiency.

Preferably, the first track and the second track are independent of each other, or the first track and the second track are the same track.

In this technical solution, if the first track and the second track are independent of each other, the two battery replacement apparatuses can move independently and operate more efficiently; if the first track and the second track are the same track, the two battery replacement apparatuses reuse the same track, which can reduce the cost of the battery replacement system.

Preferably, the second track is provided with a waiting positioning point, and the second battery replacement apparatus is used to stop at the waiting positioning point when the first battery replacement apparatus stops at the battery replacement position.

In this technical solution, when the first battery replacement apparatus is at the battery replacement position, the second battery replacement apparatus can wait at the waiting positioning point, so that neither the interference between the two battery replacement apparatuses both of which are at the battery replacement position nor the influence of the second battery replacement apparatus stopping at the exchange position on other battery replacement apparatuses in the battery compartment will be caused.

Preferably, the walking channel has a waiting position, the battery replacement position is located between the waiting position and the exchange position, and the battery replacement apparatus is used to stop at the waiting position.

In this technical solution, when the battery pack is installed on the second battery replacement apparatus, the first battery replacement apparatus and/or the second battery replacement apparatus is controlled to drive to the waiting position.

Preferably, the walking channel is provided with a limit position, and the battery replacement apparatus is further configured to stop moving when moving to the limit position along the walking channel.

In this technical solution, the battery replacement apparatus is limited by setting the limit position to prevent the battery replacement apparatus from running out of the working area, providing the working area boundary for the battery replacement apparatus, and avoiding the danger of the battery replacement apparatus caused by running out of control and escaping.

Preferably, the limit position is provided with a limit positioning point, and the battery replacement apparatus is provided with a limit sensor corresponding to the limit positioning point, and the limit sensor is used to detect whether the battery replacement apparatus has reached the limit position point.

In this technical solution, when the limit sensor detects the limit positioning point, the battery replacement apparatus stops moving, preventing the battery replacement apparatus from exceeding the limit position and causing danger.

Preferably, the limit position comprises a first limit position, the first limit position is arranged at the other side of the battery replacement position along the walking direction of the battery replacement apparatus, and the first limit position is provided with a first limit positioning point, and the battery replacement apparatus is provided with a first limit sensor.

In this technical solution, the first limit position is used to prevent the battery replacement apparatus from running out of the working area from one side of the battery replacement position, and the first limit position point and the first limit sensor are used to cooperate to achieve the above purpose.

Preferably, the walking channel is provided with an exchange position, and the battery replacement apparatus is used for moving to the exchange position along the walking channel, and the limit position further comprises a second limit position which is arranged on the other side of the exchange position along the walking direction of the battery replacement apparatus, and the second limit position is provided with a second limit positioning point, and the battery replacement apparatus is provided with a second limit sensor.

In the technical solution, the second limit position is used to prevent the battery replacement apparatus from running out of the working area from one side of the exchange position, and the second limit position point and the second limit sensor are used to cooperate to achieve the above purpose.

Preferably, the distance between the first limit positioning point and the battery replacement position does not exceed 60 mm, and the distance between the second limit positioning point and the exchange position does not exceed 60 mm.

In this technical solution, the distances between the first limit positioning point and the battery replacement position and between the second limit positioning point and the exchange position are set to be small, so as to limit the moving range of the battery replacement apparatus and reduce the requirement of the battery replacement system on the site space.

The present invention also provides a control method for the battery replacement system, the battery replacement system comprises a walking channel and a battery replacement apparatus, the battery replacement apparatus is used for removal and installation of a battery pack of an electric vehicle, and the control method for the battery replacement system comprises the following steps:

when a battery removal or battery installation signal is received, controlling the battery replacement apparatus to move to the battery replacement position along the walking channel.

In this technical solution, through the above steps, the stroke of the battery replacement apparatus is controlled according to the battery replacement signal, which is beneficial to improve the accuracy of the battery replacement apparatus moving to the designated position.

Preferably, the battery replacement position is provided with an alignment original point, the battery replacement apparatus is provided with an alignment sensor, or the battery replacement position is provided with an alignment sensor, and the battery replacement apparatus is provided with an alignment original point;

when a battery removal or battery installation signal is received, controlling the battery replacement apparatus to move to the battery replacement position along the walking channel, including the following steps:

when the alignment sensor detects the alignment original point, the battery replacement apparatus is controlled to stop moving.

In the technical solution, through the above steps, the alignment sensor and the alignment origin are used to realize that the battery replacement apparatus is accurately stopped at the battery replacement position.

Preferably, there is an exchange position on the walking channel; when a battery removal or battery installation signal is received, controlling the battery replacement apparatus to move to the battery replacement position along the walking channel, including the following step:

when receiving the battery replacement signal, the battery replacement apparatus is controlled to move to the replacement position of the battery along the walking channel.

In this technical solution, through the above step, the battery replacement apparatus can be stopped at the exchange position, the removed battery pack can be placed in the battery compartment at the exchange position, and the charged battery pack can be taken out from the battery compartment, realize the replacement of battery packs.

Preferably, after the step that when the battery removal or battery installation signal is received, the battery replacement apparatus is controlled to move to the battery replacement position along the walking channel, the following steps are further included:

controlling the battery replacement apparatus to remove the battery pack from the electric vehicle;

controlling the battery replacement apparatus to move from the battery replacement position to the exchange position.

In this technical solution, through the above steps, the battery replacement apparatus can complete the removal of the battery pack from the electric vehicle and transport the battery pack to the exchange position.

Preferably, the exchange position is provided with an exchange original point, and the battery replacement apparatus is provided with an exchange sensor, or the exchange position is provided with an exchange sensor, and the battery replacement apparatus is provided with an exchange original point;

controlling the battery replacement apparatus to move from the battery replacement position to the exchange position includes the following steps:

when the exchange sensor detects the exchange original point, the battery replacement apparatus is controlled to stop moving.

In this technical solution, the above-mentioned steps make it possible to use the exchange sensor and the replacement origin to move the battery replacement apparatus accurately to the exchange position, ensuring that the battery pack can be transported by the replacement apparatus to the battery compartment.

Preferably, the walking channel connects the battery compartment and the battery replacement position, and a deceleration positioning point is arranged on the walking channel;

controlling the battery replacement apparatus to move to the battery replacement position along the walking channel also includes the following step:

during the movement of the battery replacement apparatus along the walking channel towards the battery replacement position, it is judged whether the battery replacement apparatus has reached the deceleration positioning point, if so, the battery replacement apparatus decelerates until it reaches the battery replacement position and then stops.

In the technical solution, through the above steps, the battery replacement apparatus can be moved quickly and can be positioned accurately.

Preferably, controlling the battery replacement apparatus to move to the battery replacement position along the walking channel further includes the following steps:

S1, prestoring total distance of the walking channel and a first distance from the battery compartment to the deceleration positioning point;

S2, controlling the battery replacement apparatus to travel the first distance at a first speed;

S3, controlling the battery replacement apparatus to travel a second distance at a second speed, wherein the second distance is less than the difference between the total distance of the walking channel and the first distance, and the first speed is greater than the second speed;

S4, judging whether the battery replacement apparatus has reached the battery replacement position; if so, execute S5; otherwise, execute S3;

S5, controlling the battery replacement apparatus to stop walking.

In this technical solution, through the above steps, the battery replacement apparatus can be controlled to gradually approach the battery replacement position.

Preferably, the walking channel has a first waiting position, and the first waiting position is located between the battery replacement position and the exchange position;

the control method for the battery replacement system further comprises:

when a first waiting signal is received, the battery replacement apparatus is controlled to move to the first waiting position along the walking channel.

In this technical solution, through the above step, the first waiting position can be used to coordinate the movement route of the battery replacement apparatus when the battery replacement system is working, so as to prevent the battery replacement apparatus from interfering and colliding.

Preferably, the walking channel has a second waiting position, and the battery replacement position is located between the second waiting position and the exchange position;

the control method for the battery replacement system further includes:

when a second waiting signal is received, the battery replacement apparatus is controlled to move to the second waiting position along the walking channel.

In this technical solution, through the above step, the second waiting position can be used to coordinate the movement route of the battery replacement apparatus when the battery replacement system is working, so as to prevent the battery replacement apparatus from interfering and colliding.

Preferably, there are two battery replacement apparatuses, and the two battery replacement apparatuses are a first battery replacement apparatus and a second battery replacement apparatus, and a first track for the first battery replacement apparatus to walk on and a second track for the second battery replacement apparatus to walk on are arranged in the walking channel;

the control method for the battery replacement system further includes:

when a removal signal is received, the first battery replacement apparatus is controlled to move to the exchange position along the first track for battery pack removal, and the second battery replacement apparatus is controlled to move to the exchange position along the second track to obtain the battery pack of the corresponding type.

In this technical solution, through the above steps, two battery replacement apparatuses can be controlled to work in the battery replacement system, improve the battery replacement efficiency.

Preferably, the first track and the second track are two different tracks,

or the first track and the second track are the same track.

In this technical solution, if the first track and the second track are independent of each other, the two battery replacement apparatuses can move independently, and the operation efficiency is high; if the first track and the second track are the same track, the two battery replacement apparatuses reusing the same track can reduce the cost of the battery replacement system.

Preferably, the control method for the battery replacement system further includes:

when receiving a replacement signal, the first battery replacement apparatus is controlled to drive to the exchange position.

In this technical solution, through the above steps, the first battery replacement apparatus can be controlled to travel to the exchange position, so that the first battery replacement apparatus enters the battery compartment.

Preferably, the walking channel has a waiting position, and the battery replacement position is located between the waiting position and the exchange position;

the control method for the battery replacement system further includes:

when the second battery replacement apparatus finishes installing the battery pack, the first battery replacement apparatus and/or the second battery replacement apparatus are controlled to drive to the waiting position.

In this technical solution, through the above steps, the second battery replacement apparatus can be controlled to drive to the waiting position.

Preferably, the control method for the battery replacement system further includes the following steps:

before the first battery replacement apparatus drives away from the battery replacement position, the second battery replacement apparatus is controlled to remove a battery pack adapted to the electric vehicle from the battery compartment, and then waiting for the first battery replacement apparatus to drive away from the battery replacement position.

In the technical solution, through the above steps, interference between the second battery replacement apparatus and the first battery replacement apparatus can be avoided.

Preferably, the second track is provided with a waiting positioning point, the second battery replacement apparatus is provided with a waiting positioning sensor for detecting the waiting positioning point, or the second battery replacement apparatus is provided with a waiting positioning point, and the second track is provided with a waiting positioning sensor for detecting the waiting positioning point;

before the first battery replacement apparatus drives away from the battery replacement position, the second battery replacement apparatus is controlled to remove a battery pack adapted to the electric vehicle from the battery compartment, and then waiting for the first battery replacement apparatus to drive away from the battery replacement position, including the following steps:

before the first battery replacement apparatus drives away from the battery replacement position, the second battery replacement apparatus is controlled to stop at the waiting positioning point.

In this technical solution, through the above steps, the second battery replacement apparatus can use the waiting positioning point to wait for the first battery replacement apparatus to drive away from the battery replacement position.

Preferably, the walking channel is provided with a limit position, and the control method for the battery replacement system further includes:

the battery replacement apparatus is controlled to stop at the limit position of the walking channel.

In the technical solution, through the above steps, the battery replacement apparatus can be prevented from leaving the working area and causing danger.

Preferably, the limit position includes a first limit position, the first limit position is arranged at the other side of the battery replacement position along the walking direction of the battery replacement apparatus, and the first limit position is provided with a first limit positioning point, the battery replacement apparatus is provided with a first limit sensor, or the first limit position is provided with a first limit sensor, and the battery replacement apparatus is provided with a first limit positioning point;

the battery replacement apparatus is controlled to stop at the limit position of the walking channel, includes:

when the first limit sensor detects the first limit positioning point, the battery replacement apparatus is controlled to stop moving.

In this technical solution, through the above steps, the first limit position can prevent the battery replacement apparatus from running out of the working area from one side of the battery replacement position, and the first limit positioning point and the first limit sensor are used to cooperate to achieve the above purpose.

Preferably, the walking channel is provided with an exchange position, the limit position further includes a second limit position, when the battery replacement apparatus moves to the exchange position along the walking channel, the second limit position is arranged at the other side of the exchange position along the walking direction of the battery replacement apparatus, the second limit position is provided with a second limit positioning point, the battery replacement apparatus is provided with a second limit sensor, or the second limit position is provided with a second limit sensor, and the battery replacement apparatus is provided with a second limit positioning point;

the battery replacement apparatus is controlled to stop at the limit position of the walking channel, includes:

when the second limit sensor detects the second limit positioning point, the battery replacement apparatus is controlled to stop moving.

In this technical solution, through the above steps, the second limit position can prevent the battery replacement apparatus from running out of the working area from the two sides of the battery replacement position, and the second limit positioning point and the second limit sensor are used to cooperate to achieve the above purpose.

The positive improvement effect of the present invention is that the battery replacement system and the control method for the battery replacement system of the present invention can realize rapid battery replacement operation, and improve the battery replacement efficiency and the stability of the battery replacement operation.

### BRIEF DESCRIPTION OF THE DRAWINGS

FIG. 1 is a schematic structural diagram of a battery replacement system according to Embodiment 1 of the present invention.

FIG. 2 is a schematic diagram of steps of a control method for the battery replacement system according to Embodiment 3 of the present invention.

FIG. 3 is a schematic diagram of steps of a control method for the battery replacement system according to Embodiment 5 of the present invention.

### DESCRIPTION OF REFERENCE NUMERALS

battery replacement apparatus 1
first battery replacement apparatus 11
second battery replacement apparatus 12
walking channel 2
first track 21
second track 22
electric vehicle 3
battery replacement position 4
battery compartment 5
exchange position 6

### DETAILED DESCRIPTION OF THE PREFERRED EMBODIMENT

The present invention is further described below by means of embodiments, but the present invention is not limited to the scope of the embodiments.

### Embodiment 1

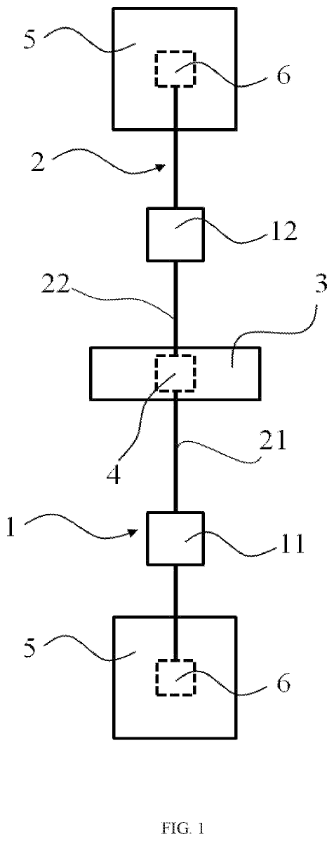

As shown in FIG. 1, the present invention provides a battery replacement system, the battery replacement system includes a walking channel 2 and a battery replacement apparatus 1, wherein the walking channel 2 is provided with a battery replacement position 4, when removing or installing the battery, the battery replacement apparatus 1 moves to the battery replacement position 4 along the walking channel 2. By controlling the battery replacement apparatus 1 to move in the walking channel 2, the battery replacement apparatus 1 can be aligned with the electric vehicle 3, the removal or installation of the battery pack is completed, and the operation stability of the battery replacement system is improved.

The battery replacement position 4 is provided with an alignment original point, and the battery replacement apparatus 1 is provided with an alignment sensor, which is used to detect whether the battery replacement apparatus 1 has reached the alignment original point. The alignment sensor is used to detect the position of the alignment original point, when the alignment sensor detects the alignment original point, it means that the battery replacement apparatus 1 has reached the battery replacement position 4, so that the battery replacement apparatus 1 can accurately stop at the battery replacement position 4. In other preferred embodiments, the position of the alignment original point and the alignment sensor can also be interchanged, that is, the alignment original point can be arranged at the battery replacement apparatus 1, and the alignment sensor can be arranged at the battery replacement position, which can also achieve the above effect.

There is an exchange position 6 on the walking channel 2, and the battery replacement apparatus 1 is used to move to the exchange position 6 along the travel channel 2, and the battery replacement apparatus 1 is also used to exchange the battery pack to a battery compartment 5 at the exchange position 6. The battery replacement apparatus can hand over the battery to the battery transfer apparatus, and then the battery transfer apparatus can place the battery into the battery compartment 5, and the battery compartment 5 can be used to store the battery pack, and can also be used to charge the battery pack. The battery replacement apparatus 1 can be stopped at the exchange position 6, and the removed battery pack can be placed in the battery compartment 5 at the exchange position 6, and the charged battery pack can be taken out from the battery compartment 5 to realize the exchange of the battery pack.

The exchange position 6 is provided with an exchange original point, and the battery replacement apparatus 1 is provided with an exchange sensor, and the exchange sensor is used to detect whether the battery replacement apparatus 1 has reached the exchange original point. By using the exchange sensor to detect the exchange original point, the battery replacement apparatus 1 can be accurately positioned at the exchange position 6, and the operation of replace the battery pack can be guaranteed to run stably.

The walking channel 2 connects the battery compartment 5 and the battery replacement position 4, the walking channel 2 is provided with a deceleration positioning point, the battery replacement apparatus 1 is provided with a deceleration sensor corresponding to the deceleration positioning point, the deceleration sensor is used to detect whether the battery replacement apparatus 1 has reached the deceleration positioning point, the battery replacement apparatus 1 moves along the walking channel 2 towards the battery replacement position and passes the deceleration positioning point and then decelerates. The battery replacement apparatus 1 moves between the battery compartment 5 and the battery replacement position 4, the battery replacement apparatus 1 moves quickly before it reaches the deceleration positioning point to improve operational efficiency; the battery replacement apparatus 1 decelerates after passing the deceleration positioning point to ensure that the battery replacement apparatus can accurately stop at the exchange position, reducing control difficulties and improving the operational safety of the battery replacement apparatus 1.

The walking channel 2 has a first waiting position, the first waiting position is located between the battery replacement position 4 and the exchange position 6, and the battery replacement apparatus 1 is used to stop at the first waiting position. Before the electric vehicle is parked in place, the battery replacement apparatus 1 can stay in the first waiting position in advance, after the electric vehicle is parked in place, the battery replacement apparatus 1 can enter the battery replacement position 4 from the first waiting position to remove and install the battery, a plurality of battery replacement apparatuses 1 may exist in the battery replacement system at the same time, when there is a battery replacement apparatus 1 at the battery replacement position 4 to remove and install the battery, other battery replacement apparatuses 1 can stop at the first waiting position. By providing a first waiting position, the time required to move horizontally when the battery replacement apparatus 1 goes underneath the vehicle for battery removal can be reduced, improving the battery replacement efficiency.

Further, the walking channel 2 also has a second waiting position, the battery replacement position 4 is located between the second waiting position and the exchange position 6, and the battery replacement apparatus 1 is used to stop at the second waiting position. After the battery replacement apparatus 1 moves along the walking channel 2 to the battery replacement position 4 to remove and install the battery, it continues to move forward along the original walking direction to the second waiting position, so as to perform the next battery replacement action. For example, after removing the battery, it can wait for another battery replacement apparatus to move to the battery replacement position along the same walking channel to perform the battery-installing action, or after the battery is installed, move to the second waiting position and wait for the electric vehicle to leave.

In this embodiment, the number of battery replacement apparatus 1 is two, the two battery replacement apparatuses 1 are a first battery replacement apparatus 11 and a second battery replacement apparatus 12, and a first track 21 for the first battery replacement apparatus 11 to walk on and a second track 22 for the second battery replacement apparatus 12 to walk on are arranged in the walking channel 2. The two battery replacement apparatus 1 respectively perform the operations of removing the battery pack and installing the battery pack, thereby improving the battery replacement speed. For example, when the first battery replacement apparatus 11 removes the battery pack at the battery replacement position 4, the second battery replacement apparatus 12 can take out the charged battery pack from the battery compartment 5, when the first battery replacement apparatus 11 completes the removal of the battery pack and after leaving the battery replacement position 4, the second battery replacement apparatus 12 can move the battery pack to the battery replacement position 4 and install the battery pack on the electric vehicle, at this time, the first battery replacement apparatus 11 can complete the replacement of the new and old batteries in the battery compartment 5, the two battery replacement apparatuses 1 can respectively run on the first track 21 and the second track 22 respectively, and the battery replacement efficiency is high.

In this embodiment, as shown in FIG. 1, the first track 21 and the second track 22 are independent of each other, the first track 21 connects the battery replacement position 4 and the battery compartment 5, while the second track 22 connects the battery replacement position 4 and the other battery compartment 5, the two replacement apparatuses 1 can move independently and operate more efficiently. In some other embodiments, the first track 21 and the second track 22 can also be the same track, and the two battery replacement apparatuses 1 reuse the same track, which can reduce the cost of the battery replacement system.

The second track 22 is provided with a waiting positioning point and accordingly the second battery replacement apparatus 12 is provided with a waiting positioning sensor for detecting the waiting positioning point and the second battery replacement apparatus 12 is used to stop at the waiting positioning point when the first battery replacement apparatus 11 is stopped at the battery replacement position 4. When the first battery replacement apparatus 11 is in battery replacement position 4, the second battery replacement apparatus 12 can wait at the waiting positioning point so that there is no consequence of interference between both battery replacement apparatuses 1 in battery replacement position 4, nor does the stopping of the second battery replacement apparatus 12 in the exchange position 6 affect the other battery replacement apparatus 1 in the battery compartment 5. In some other embodiments, the waiting positioning point can also be arranged at other positions of the walking channel 2, not limited to the track. In some preferred embodiments, the waiting positioning point can also be arranged at the second battery replacement apparatus 12, and the waiting positioning sensor can be arranged at the walking channel 2, which can also achieve the above effects.

The walking channel 2 has a waiting position, the battery replacement position 4 is located between the waiting position and the exchange position 6, and the battery replacement apparatus 1 is used to stop at the waiting position. When the battery pack is installed in the second battery replacement apparatus 12, the first battery replacement apparatus 11 and/or the second battery replacement apparatus 12 is controlled to travel to the waiting position.

The walking channel 2 is provided with a limit position, and the battery replacement apparatus 1 is also used to stop moving when moving along the walking channel 2 to the limit position. By setting the limit position, the battery replacement apparatus 1 is limited to prevent the battery replacement apparatus 1 from running out of the working area, providing the working area boundary for the battery replacement apparatus 1, and avoiding the danger of the battery replacement apparatus 1 caused by running out of control and escaping.

In this embodiment, the limit position is provided with a limit positioning point, the battery replacement apparatus 1 is provided with a limit sensor corresponding to the limit positioning point, and the limit sensor is used to detect whether the battery replacement apparatus 1 has reached the limit positioning point. When the limit sensor detects the limit positioning point, the battery replacement apparatus 1 stops moving, so as to prevent the battery replacement apparatus 1 from exceeding the limit position and causing danger. In some other embodiments, the limit positioning point may also be arranged at the battery replacement apparatus 1, and correspondingly, the limit sensor is arranged at the limit position, which can also achieve the above effects.

The limit position includes a first limit position, the first limit position is arranged at the other side of the battery replacement position 4 along the walking direction of the battery replacement apparatus 1, the first limit position is provided with a first limit positioning point, and the battery replacement apparatus 1 is provided with a first limit sensor. The first limit position is used to prevent the battery replacement apparatus 1 from running out of the working area from one side of the battery replacement position 4, and the first limit positioning point and the first limit sensor are used to cooperate to achieve the above purpose. In other preferred embodiments, the positions of the first limit positioning point and the first limit sensor can be interchanged.

The limit position also includes a second limit position, the second limit position is arranged at the other side of the exchange position 6 along the walking direction of the battery replacement apparatus 1, the second limit position is provided with a second limit positioning point, and the battery replacement apparatus 1 is provided with a first second limit sensor. The second limit position is used to prevent the battery replacement apparatus 1 from running out of the working area from one side of the exchange position 6, and the second limit position point and the second limit sensor are used to cooperate to achieve the above purpose. In other preferred embodiments, the positions of the second limit positioning point and the second limit sensor can be interchanged.

The distance between the first limit positioning point and the battery replacement position 4 does not exceed 60 mm, and the distance between the second limit positioning point and the exchange position 6 does not exceed 60 mm. The distances between the first limit positioning point and the battery replacement position 4 and between the second limit positioning point and the exchange position 6 are set to be small to limit the movement range of the battery replacement apparatus 1 and reduce the space requirements of the battery replacement system on the site space.

### Embodiment 2

The present invention also provides a control method for the battery replacement system, the battery replacement system includes a walking channel 2 and a battery replacement apparatus 1, the battery replacement apparatus 1 is used for removing and installing a battery pack of an electric vehicle 3, the control method for the battery replacement system includes the following steps:

S10, when receiving a battery removal or battery installation signal, controlling the battery replacement apparatus 1 to move to the battery replacement position 4 along the walking channel 2.

When the battery removal or battery installation signal is received by the battery replacement apparatus, the controller of the battery replacement apparatus controls the battery replacement apparatus 1 to move to the battery replacement position along the walking channel 2, through the above steps, precise control of the horizontal movement of the battery replacement apparatus 1 can be achieved, thus improving the stability of the operation of the battery replacement system.

In this embodiment, the battery replacement position 4 is provided with an alignment original point, and the battery replacement apparatus 1 is provided with an alignment sensor. In other embodiments, the alignment sensor may also be arranged at the battery replacement position 4, and the alignment original point may be arranged at the battery replacement apparatus 1.

The S10 includes the following steps:

S101, when the alignment sensor detects the alignment original point, controlling the battery replacement apparatus 1 to stop moving.

Through the above steps, the battery replacement apparatus 1 can be accurately stopped at the battery replacement position 4 by using the alignment sensor and the alignment original point.

There is also an exchange position 6 on the walking channel 2.

The control method of the battery replacement system further includes the following steps:

S20, when receiving the battery replacement signal, controlling the battery replacement apparatus 1 to move to the exchange position 6 of the battery along the walking channel 2.

When the battery replacement apparatus receives the battery replacement signal, the controller of the battery replacement apparatus controls the battery replacement apparatus 1 to move to the exchange position 6 along the walking channel 2, through the above steps, the battery replacement apparatus 1 can be stopped at the exchange position 6, and the removed battery pack is placed in the battery compartment 5 at the exchange position 6, and the charged battery pack is taken out from the battery compartment 5, so that the battery pack can be replaced.

### Embodiment 3

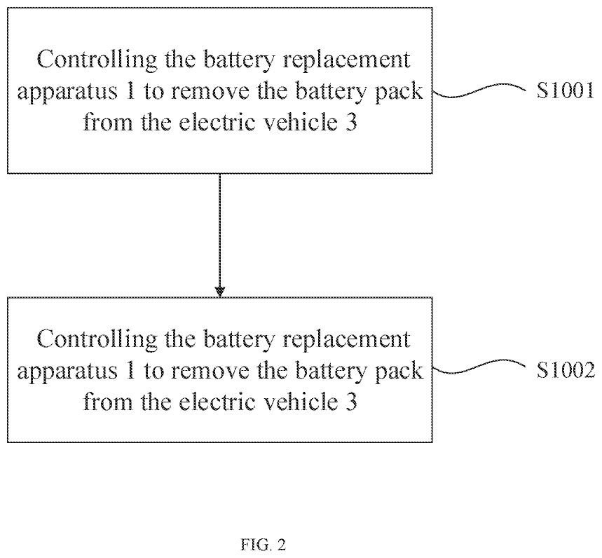

As shown in FIG. 2, the control method for the battery replacement system in this embodiment adds the following steps on the basis of embodiment 2.

After S10, the following steps are also included:

S1001, controlling the battery replacement apparatus 1 to remove the battery pack from the electric vehicle 3;

S1002, controlling the battery replacement apparatus 1 to move from the battery replacement position 4 to the exchange position 6.

Through the above steps, the battery replacement apparatus 1 can remove the battery pack from the electric vehicle 3 and transport the battery pack to the exchange position 6.

In this embodiment, an exchange original point is provided at the exchange position 6, and an exchange sensor is provided on the battery replacement apparatus 1; in other embodiments, the positions of the replacement original and the exchange sensor can also be reversed.

S1002 includes the following steps:

S10021, when the exchange sensor detects the exchange original point, controlling the battery replacement apparatus 1 to stop moving.

Through the above steps, the exchange sensor and the exchange original point can be used to accurately move the battery replacement apparatus 1 to the exchange position 6, ensuring that the battery replacement apparatus 1 can transport the battery pack into the battery compartment 5.

### Embodiment 4

The control method for the battery replacement system of this embodiment adds the following steps on the basis of embodiment 3.

The walking channel 2 connects the battery compartment 5 and the battery replacement position 4, and a deceleration positioning point is arranged at the walking channel 2.

The S10 also includes the following steps:

S10010, during the process of the battery replacement apparatus 1 moving along the walking channel 2 towards the battery replacement position 4, it is judged that whether the battery replacement apparatus 1 has reached the deceleration positioning point, if so, the battery replacement apparatus 1 decelerates and moves until it reaches the battery replacement position 4 and then stops.

Through the above steps, the battery replacement apparatus 1 can be moved quickly and can be positioned accurately.

### Embodiment 5

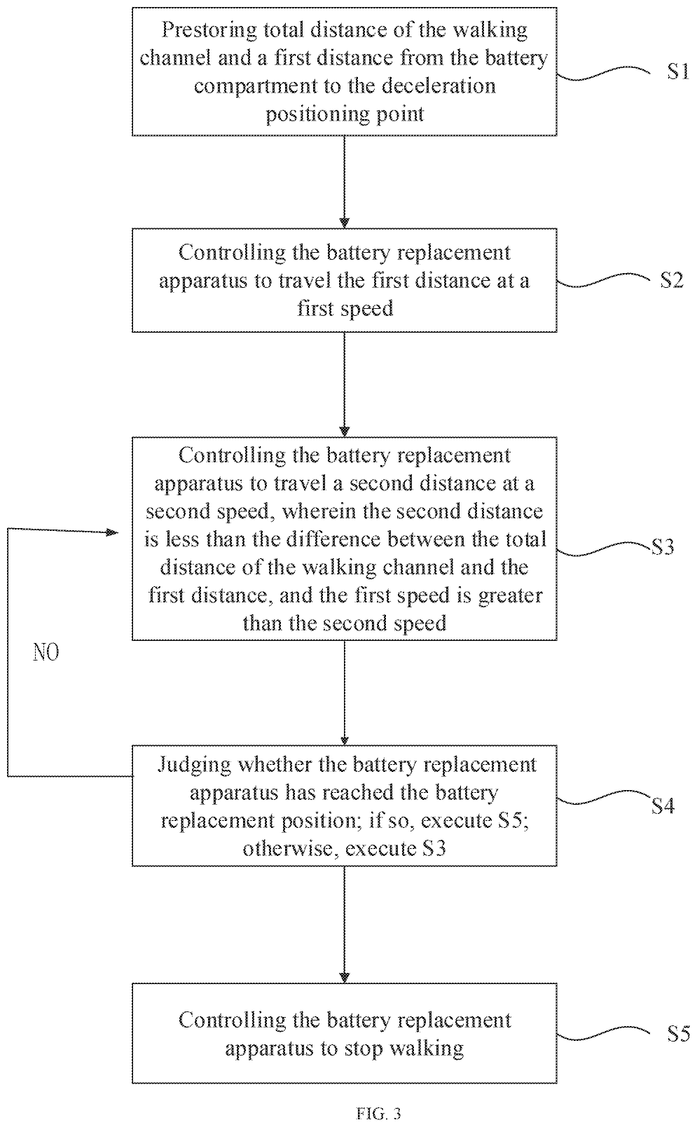

As shown in FIG. 3, the control method for the battery replacement system in this embodiment adds the following steps on the basis of embodiment 4.

S10010 also includes the following steps:

S1, prestoring total distance of the walking channel 2 and a first distance from the battery compartment 5 to the deceleration positioning point;

S2, controlling the battery replacement apparatus 1 to travel a first distance at a first speed;

S3, controlling the battery replacement apparatus 1 to travel a second distance at a second speed, the second distance is less than the difference between the total distance of the walking channel 2 and the first distance, and the first speed is greater than the second speed;

S4, judging whether the battery replacement apparatus 1 has reached the battery replacement position 4; if so, execute S5; otherwise, execute S3;

S5, controlling the battery replacement apparatus 1 to stop walking.

Through the above steps, the battery replacement apparatus 1 can be controlled to gradually approach the battery replacement position 4 to ensure that the battery replacement apparatus can be accurately parked to the battery replacement position.

### Embodiment 6

The control method for the battery replacement system in this embodiment adds the following steps on the basis of embodiment 2.

The walking channel 2 has a first waiting position, and the first waiting position is located between the battery replacement position 4 and the exchange position 6.

The control method for the battery replacement system further includes:

S1010, when receiving a first waiting signal, controlling the battery replacement apparatus 1 to move to the first waiting position along the walking channel 2.

When the battery replacement apparatus 1 receives the first wait signal, the controller of the battery replacement apparatus 1 controls the battery replacement apparatus 1 to move to the first wait position along the walking channel 2, through the above steps, the battery replacement apparatus 1 can stay in the first wait position in advance before the electric vehicle stops in place, and after the electric vehicle stops in place, the battery replacement apparatus 1 can enter the battery replacement position 4 from the first wait position to perform the battery removal and installation, if there can be more than one battery replacement apparatus 1 at the same time in a battery replacement system, when there is a battery removal and installation by the battery replacement apparatus 1 at the battery removal and installation position 4, other battery replacement apparatuses 1 can stop at the first wait position. By setting the first waiting position, the time required for horizontal movement of the battery replacement apparatus 1 when it enters the bottom of the vehicle for battery removal and installation can be reduced, and improves the battery replacement efficiency.

The walking channel 2 also has a second waiting position, and the battery replacement position 4 is located between the second waiting position and the exchange position 6.

The control method for the battery replacement system further includes:

S1020, when receiving a second waiting signal, controlling the battery replacement apparatus 1 to move to the second waiting position along the walking channel 2.

When the battery replacement apparatus 1 receives the second waiting signal, the controller of the battery replacement apparatus 1 controls the battery replacement apparatus 1 to move to the second waiting position along the walking channel 2, through the above steps, the battery replacement apparatus 1 can stop at the second waiting position. After the battery replacement apparatus 1 moves along the walking channel 2 to the battery replacement position 4 to remove and install the battery, it continues to move forward along the original walking direction to the second waiting position, so as to perform the next battery replacement action. For example, after removing the battery, it can wait for another battery replacement apparatus to move to the battery replacement position along the same walking channel to perform the battery-installing action, or after the battery is installed, it moves to the second waiting position and waits for the electric vehicle to leave.

### Embodiment 7

The control method for the battery replacement system of this embodiment adds the following steps on the basis of embodiment 2.

The number of battery replacement apparatus 1 is two, and the two battery replacement apparatuses 1 are a first battery replacement apparatus 11 and a second battery replacement apparatus 12, and a first track 21 for the first battery replacement apparatus 11 to walk on and a second track 22 for the second battery replacement apparatus 12 to walk on are arranged in the walking channel 2.

The control method of the battery replacement system further includes:

when receiving a removal signal, controlling the first battery replacement apparatus 11 to move to the battery replacement position 4 along the first track 21 to remove the battery pack, and controlling the second battery replacement apparatus 12 to move to the exchange position 6 along the second track 22 to obtain the corresponding model battery pack.

When the first battery replacement apparatus 11 and the second battery replacement apparatus 12 receive the removal signal, the first battery replacement apparatus 11 is controlled to move along the first track 21 to the battery replacement position 4 for battery pack removal, and the second battery replacement apparatus 12 is controlled to move along the second track 22 to the exchange position 6 to obtain the battery pack of the corresponding type. Through the above steps, the two battery replacement apparatuses 1 can be controlled to work in the battery replacement system, thereby the battery replacement efficiency is improved.

The first track 21 and the second track 22 can be two different tracks, the first track 21 connects the battery replacement position 4 and the battery compartment 5, while the second track 22 connects the battery replacement position 4 and the other battery compartment 5, each battery replacement apparatus 1 can be moved independently, and the operation efficiency is high. In some other embodiments, the first track 21 and the second track 22 can also be the same track, and the two battery replacement apparatuses 1 reuse the same track, which can reduce the cost of the battery replacement system.

### Embodiment 8

The control method for the battery replacement system in this embodiment adds the following steps on the basis of embodiment 7.

The control method of the battery replacement system further includes:

when the replacement signal is received, the first battery replacement apparatus 11 is controlled to drive to the exchange position 6.

When the first battery replacement apparatus 11 receives a replacement signal, the first battery replacement apparatus 11 is controlled to drive to the exchange position 6. Through the above steps, the first battery replacement apparatus 11 can be controlled to drive to the exchange position 6, so that the first battery replacement apparatus 11 enters the battery compartment 5.

The walking channel 2 has a waiting position, and the battery replacement position 4 is located between the waiting position and the exchange position 6;

the control method of the battery replacement system further includes:

S100100, when the second battery replacement apparatus 12 finishes installation of the battery pack, controlling the first battery replacement apparatus 11 and/or the second battery replacement apparatus 12 to drive to a waiting position.

Through the above steps, the second battery replacement apparatus 12 can be controlled to drive to the waiting position.

The control method for the battery replacement system further includes the following steps:

S100101, before the first battery replacement apparatus 11 drives away from the battery replacement position 4, controlling the second battery replacement apparatus 12 to remove the battery pack suitable for the electric vehicle 3 from the battery compartment 5, and then wait for the first battery replacement apparatus 11 to drive away from the battery replacement position 4.

Through the above steps, interference between the second battery replacement apparatus 12 and the first battery replacement apparatus 11 can be avoided.

The second track 22 is provided with a waiting positioning point, and correspondingly, the second battery replacement apparatus 12 is provided with a waiting positioning sensor for detecting the waiting positioning point. In other embodiments, the waiting positioning point can also be arranged at other positions of the walking channel 2, not limited to the track. In some preferred embodiments, the waiting positioning point can also be arranged at the second battery replacement apparatus 12, and the waiting positioning sensor can be arranged at the walking channel 2.

S100101 includes the following steps:

S1001011, before the first battery replacement apparatus 11 drives away from the battery replacement position 4, the second battery replacement apparatus 12 stops at the waiting positioning point.

Through the above steps, the second battery replacement apparatus 12 can use the waiting positioning point to wait for the first battery replacement apparatus 11 to drive away from the battery replacement position 4.

### Embodiment 9

The control method for the battery replacement system in this embodiment adds the following steps on the basis of embodiment 2.

The walking channel 2 is provided with a limit position, and the control method of the battery replacement system further includes:

S11, controlling the battery replacement apparatus 1 to stop at the limit position of the walking channel 2.

Through the above steps, the battery replacement apparatus 1 can be prevented from driving away from the working area and causing danger.

Preferably, the limit position includes a first limit position, the first limit position is arranged at the other side of the battery replacement position 4 along the walking direction of the battery replacement apparatus 1, the first limit position is provided with a first limit positioning point, and the battery replacement apparatus 1 is provided with a first limit sensor. In other preferred embodiments, the positions of the first limit positioning point and the first limit sensor can be interchanged.

Controlling the battery replacement apparatus 1 to stop at the limit position of the walking channel 2, includes:

S111, when the first limit sensor detects the first limit positioning point, controlling the battery replacement apparatus 1 to stop moving.

Through the above steps, the first limit position can prevent the battery replacement apparatus 1 from driving out of the working area from one side of the battery replacement position 4, and the first limit positioning point and the first limit sensor can be used to cooperate to achieve the above purpose.

The limit position also includes a second limit position, which is arranged on the other side of the exchange position 6 along the walking direction of the battery replacement apparatus 1, and the second limit position is provided with a second limit positioning point, and the battery replacement apparatus 1 is provided with a second limit sensor. In other preferred embodiments, the positions of the second limit positioning point and the second limit sensor can be interchanged.

The S11 also includes:

S112, when the second limit sensor detects the second limit positioning point, controlling the battery replacement apparatus 1 to stop moving.

By setting the first limit positioning point and the first limit sensor, the potential safety hazard caused by the failure of the alignment original point can be prevented because the battery replacement apparatus can't stop on the walking channel in time. By setting the second limit positioning point and the second limit sensor, the collision between the battery replacement apparatus and other apparatuses in the battery compartment caused by the failure of the exchange original point can be prevented.

Although the specific embodiments of the present invention have been described above, those skilled in the art should understand that this is only an example, and the scope of protection of the present invention is defined by the appended claims. Those skilled in the art can make various changes or modifications to these embodiments without departing from the principle and essence of the present invention, but these changes and modifications all fall within the scope of protection of the present invention.

1. A battery replacement system, wherein the battery replacement system comprises:
a walking channel, a battery replacement position is provided on the walking channel;
a battery replacement apparatus, the battery replacement apparatus is used for moving to the battery replacement position along the walking channel.

2. The battery replacement system according to claim 1, wherein the battery replacement position is provided with an alignment original point, the battery replacement apparatus is provided with an alignment sensor, or the battery replacement position is provided with an alignment sensor, the battery replacement apparatus is provided with an alignment origin, and the alignment sensor is used to detect whether the battery replacement apparatus has reached the alignment original point.

3. The battery replacement system according to claim 1, wherein an exchange position is provided on the walking channel, and the battery replacement apparatus is used to move to the exchange position along the walking channel, and the battery replacement apparatus is also used to exchange the battery pack to a battery compartment at the exchange position.

4. The battery replacement system according to claim 3, wherein the exchange position is provided with an exchange original point, and the battery replacement apparatus is provided with an exchange sensor, or the exchange position is provided with an exchange sensor, and the replacement apparatus is provided with an exchange original point, and the exchange sensor is used for detecting whether the battery replacement apparatus has reached the exchange original point.

5. The battery replacement system according to claim 3, wherein the walking channel connects the battery compartment and the battery replacement position, the walking channel is provided with a deceleration positioning point, and the battery replacement apparatus is provided with a deceleration sensor corresponding to the deceleration positioning point, and the deceleration sensor is used for detecting whether the battery replacement apparatus has reached the deceleration positioning point, and the battery replacement apparatus is also used for moving towards the battery replacement position along the walking channel to pass through the deceleration positioning point, and then decelerate the movement.

6. The battery replacement system according to claim 3, wherein the walking channel has a first waiting position, the first waiting position is located between the battery replacement position and the exchange position, and the battery replacement apparatus is used for stopping at the first waiting position;
and/or, the walking channel has a second waiting position, the battery replacement position is located between the second waiting position and the exchange position, and the battery replacement apparatus is used for stopping at the second waiting position.

7. The battery replacement system according to claim 3, wherein there are two battery replacement apparatuses, and the two battery replacement apparatuses are a first battery replacement apparatus and a second battery replacement apparatus, a first track for the first battery replacement apparatus to walk on and a second track for the second battery replacement apparatus to walk on are arranged in the walking channel, the first track connects the battery compartment and the battery replacement position, and the second track connects the battery compartment and the battery replacement position;
preferably, the first track and the second track are independent of each other, or the first track and the second track are the same track.

8. The battery replacement system according to claim 7, wherein the second track is provided with a waiting positioning point and the second battery replacement apparatus is used to stop at the waiting positioning point when the first battery replacement apparatus stops at the battery replacement position.

9. The battery replacement system according to claim 3, wherein the walking channel has a waiting position, the battery replacement position is located between the waiting position and the exchange position, and the battery replacement apparatus is used for stopping at the waiting position.

10. The battery replacement system according to claim 1, wherein the walking channel is provided with a limit position, and the battery replacement apparatus is further configured to stop moving when moving to the limit position along the walking channel; preferably, the limit position is provided with a limit positioning point, and the battery replacement apparatus is provided with a limit sensor corresponding to the limit positioning point, and the limit sensor is used for detecting whether the battery replacement apparatus has reached the limit positioning point;
preferably, the limit position comprises a first limit position, the first limit position is arranged at the other side of the battery replacement position along the walking direction of the battery replacement apparatus, the first limit position is provided with a first limit positioning point, and the battery replacement apparatus is provided with a first limit sensor;
preferably, the walking channel is provided with an exchange position, and the battery replacement apparatus is used for moving to the exchange position along the walking channel, and the limit position further comprises a second limit position which is arranged on the other side of the exchange position along the walking direction of the battery replacement apparatus, and the second limit position is provided with a second limit positioning point, and the battery replacement apparatus is provided with a second limit sensor.

11. A control method for the battery replacement system, the battery replacement system comprises a walking channel and a battery replacement apparatus, and the battery replacement apparatus is used for removal and installation of a battery pack of an electric vehicle, wherein the control method for the battery replacement system comprises the following steps:
when a battery removal or battery installation signal is received, controlling the battery replacement apparatus to move to the battery replacement position along the walking channel.

12. The control method for the battery replacement system according to claim 11, wherein the battery replacement position is provided with an alignment original point, the battery replacement apparatus is provided with an alignment sensor, or the battery replacement position is provided with an alignment sensor, and the battery replacement apparatus is provided with an alignment original point;
when a battery removal or battery installation signal is received, controlling the battery replacement apparatus to move to the battery replacement position along the walking channel comprises the following steps:
when the alignment sensor detects the alignment original point, controlling the battery replacement apparatus to stop moving.

13. The control method for the battery replacement system according to claim 11, wherein there is an exchange position on the walking channel;
the control method for the battery replacement system further includes the following steps:
when the battery replacement signal is received, controlling the battery replacement apparatus to move to the exchange position of the battery along the walking channel.

14. The control method for the battery replacement system according to claim 13, wherein
after the step that when a battery removal or battery installation signal is received, controlling the battery replacement apparatus to move to the battery replacement position along the walking channel, the following steps are further included:
controlling the battery replacement apparatus to remove the battery pack from the electric vehicle;
controlling the battery replacement apparatus to move from the battery replacement position to the exchange position;
preferably, the exchange position is provided with an exchange original point, and the battery replacement apparatus is provided with an exchange sensor, or the exchange position is provided with an exchange sensor, and the battery replacement apparatus is provided with an exchange original point;
controlling the battery replacement apparatus to move from the battery replacement position to the exchange position includes the following steps:
when the exchange sensor detects the exchange original point, the battery replacement apparatus is controlled to stop moving.

15. The control method for the battery replacement system according to claim 14,
wherein the walking channel connects the battery compartment and the battery replacement position, and a deceleration positioning point is arranged on the walking channel;
controlling the battery replacement apparatus to move to the battery replacement position along the walking channel also includes the following steps:
during the movement of the battery replacement apparatus along the walking channel towards the battery replacement position, it is judged whether the battery replacement apparatus has reached the deceleration positioning point, if so the battery replacement apparatus decelerates until it reaches the battery replacement position and then stops;
preferably, controlling the battery replacement apparatus to move to the battery replacement position along the walking channel further includes the following steps:
S1, prestoring total distance of the walking channel and a first distance from the battery compartment to the deceleration positioning point;
S2, controlling the battery replacement apparatus to travel the first distance at a first speed;
S3, controlling the battery replacement apparatus to travel a second distance at a second speed, wherein the second distance is less than the difference between the total distance of the walking channel and the first distance, and the first speed is greater than the second speed;
S4, judging whether the battery replacement apparatus has reached the battery replacement position; if so, execute S5; otherwise, execute S3;
S5, controlling the battery replacement apparatus to stop walking.

16. The control method for the battery replacement system according to claim 13, wherein the walking channel has a first waiting position, and the first waiting position is located between the battery replacement position and the exchange position;
the control method for the battery replacement system further comprises:
when a first waiting signal is received, controlling the battery replacement apparatus to move to the first waiting position along the walking channel;
and/or, the walking channel has a second waiting position, and the battery replacement position is located between the second waiting position and the exchange position;
the control method for the battery replacement system further comprises:
when a second waiting signal is received, controlling the battery replacement apparatus to move to the second waiting position along the walking channel.

17. The control method for the battery replacement system according to claim 13, wherein there are two battery replacement apparatuses, the two battery replacement apparatuses are a first battery replacement apparatus and a second battery replacement apparatus, and a first track for the first battery replacement apparatus to walk on and a second track for the second battery replacement apparatus to walk on are arranged in the walking channel;
the control method for the battery replacement system further comprises:
when a removal signal is removed, controlling the first battery replacement apparatus to move to the battery replacement position along the first track to remove the battery pack, and controlling the second battery replacement apparatus to move to the exchange position along the second track to obtain the battery pack of the corresponding type;
preferably, the first track and the second track are two different tracks,
or, the first track and the second track are the same track.

18. The control method for the battery replacement system according to claim 17,
wherein the control method for the battery replacement system further comprises:
when receiving a replacement signal, controlling the first battery replacement apparatus to drive to the exchange position;
and/or, the walking channel has a waiting position, and the battery replacement position is located between the waiting position and the exchange position;
the control method for the battery replacement system further comprises:
when the second battery replacement apparatus finishes installing the battery pack, the first battery replacement apparatus and/or the second battery replacement apparatus are controlled to drive to a waiting position.

19. The control method for the battery replacement system according to claim 17,
wherein the control method for the battery replacement system further comprises the following steps:
before the first battery replacement apparatus drives away from the battery replacement position, the second battery replacement apparatus is controlled to remove a battery pack adapted to the electric vehicle from the battery compartment, and then waiting for the first battery replacement apparatus to drive away from the battery replacement position;
preferably, the second track is provided with a waiting positioning point, the second battery replacement apparatus is provided with a waiting positioning sensor for detecting the waiting positioning point, or the second battery replacement apparatus is provided with a waiting positioning point, and the second track is provided with a waiting positioning sensor for detecting the waiting positioning point;
before the first battery replacement apparatus drives away from the battery replacement position, controlling the second battery replacement apparatus to remove the battery pack adapted to the electric vehicle from the battery compartment, and then waiting for the first battery replacement apparatus to drive away from the battery replacement position, including the following steps:
before the first battery replacement apparatus drives away from the battery replacement position, the second battery replacement apparatus is controlled to stop at the waiting positioning point.

20. The control method for the battery replacement system according to claim 12, wherein the walking channel is provided with a limit position, and the control method for the battery replacement system further comprises:
controlling the battery replacement apparatus to stop at the limit position of the walking channel;
preferably, the limit position comprises a first limit position, the first limit position is arranged at the other side of the battery replacement position along the walking direction of the battery replacement apparatus, and the first limit position is provided with a first limit positioning point, and the battery replacement apparatus is provided with a first limit sensor, or the first limit position is provided with a first limit sensor, and the battery replacement apparatus is provided with a first limit positioning point;
controlling the battery replacement apparatus to stop at the limit position of the walking channel includes:
when the first limit sensor detects a first limit positioning point, the battery replacement apparatus is controlled to stop moving;
preferably, the walking channel is provided with an exchange position, the limit position further includes a second limit position, when the battery replacement apparatus moves to the exchange position along the walking channel, the second limit position is arranged at the other side of the exchange position along the walking direction of the battery replacement apparatus, the second limit position is provided with a second limit positioning point, the battery replacement apparatus is provided with a second limit sensor, or the second limit position is provided with a second limit sensor, and the battery replacement apparatus is provided with a second limit positioning point;
controlling the battery replacement apparatus to stop at the limit position of the walking channel includes:
when the second limit sensor detects the second limit positioning point, the battery replacement apparatus is controlled to stop moving.
